(19) United States
(12) Patent Application Publication
(10) Pub. No.: US 2009/0289772 A1
(43) Pub. Date: Nov. 26, 2009

(54) METHOD AND SYSTEM FOR ANALYZING SIGNALS FROM ELECTRONIC TAGS, AND RECORDING MEDIUM THEREOF

(75) Inventors: Da-Gang Lee, Taipei City (TW); Hung-Jyun Mu, Taipei City (TW); Chun-Sho Lee, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INSTITUTE FOR INFORMATION INDUSTRY, Taipei (TW)

(21) Appl. No.: 12/136,054

(22) Filed: Jun. 10, 2008

(30) Foreign Application Priority Data
May 23, 2008 (TW) 97119185

(51) Int. Cl. G01S 3/02; H04Q 5/22

(52) U.S. Cl. 340/10.4

(57) ABSTRACT

A method and a system for analyzing signals from an electronic tag and a recording medium thereof are provided. The method includes the following steps. At least one reading point is defined, wherein each of the reading points includes at least one reader device. A plurality of states is defined according to logical combinations of the reading points. At least one predetermined state sequence is defined according to sequential permutations of the states. Signals are received from the electronic tag through the reader devices of the reader points. The signals received from the electronic tag are converted into the states according to the content of the signals and the definition of the reading points through a logical processing procedure, and a temporary state sequence is generated. The temporary state sequence is compared with the predetermined state sequences, and a corresponding response procedure is executed according to the comparison result.

### CROSS-REFERENCE TO RELATED APPLICATION

This application claims the priority benefit of Taiwan application serial no. 97119185, filed on May 23, 2008. The entirety of the above-mentioned patent application is hereby incorporated by reference herein and made a part of specification.

### BACKGROUND OF THE INVENTION

1. Field of the Invention

The present invention generally relates to a method and a system for analyzing signals from an electronic tag and a recording medium thereof, and more particularly, to the comparison and application of foregoing analysis result.

2. Description of Related Art

Many techniques have been developed for the positioning and tracking of moving objects. One of these techniques is to position and track moving objects by using active or passive radio frequency identification (RFID) tags. For example, the RFID tags are used for detecting people entering or leaving a factory or for tracking the movement of people within a specific region. Because the passive RFID tags have very short reading distance and long response time, active RFID tags are usually applied to the positioning and tracking of free moving objects.

According to the conventional mathematic model positioning method, the position of an object is calculated according to the variations and differences of physical characteristics, such as the angle of arrival (AOA), the time of arrival (TOA), and the time difference of arrival (TDOA), of signals from an active RFID tag by using at least three signal receivers through the three-point localization method. The disadvantage of the mathematic model positioning method is that the physical characteristics of the signals are easily affected by the environment. For example, in an indoor environment, the angles and time of signals originally issued by a signal source arriving at the receiving devices are changed, and accordingly the calculation result of the position of an object is affected, as long as someone opens a door or a dynamic/static object is placed on or removed from a signal transmission path.

According to the conventional environmental survey positioning method, with received signal strength indications (RSSI) collected by at least three signal receivers and strength distribution survey and pre-marking of object position similar to three-point localization, the position of an object is obtained by comparing the strengths of currently collected signals and pre-established strength distribution data. The disadvantage of the environmental survey positioning method is that the signal strengths are not stable. The signals issued by different RFID tags have different strengths. Even the strength of signals which are issued by the same tag from the same position and are received by the same signal receiver is easily affected by environmental factors, such as temperature, humidity, and whether anyone walks around or opens/closes a door, and accordingly the accuracy of the positioning will be reduced. Since the signal strengths are not stable, the signals have to be detected repeatedly and different environmental factors have to be considered to establish an even signal strength distribution database, and a reliable positioning result can be obtained through analysis of this database. However, it is difficult to carry out repeated signal detections and establish reliable even distribution data in an actual application.

In the conventional methods described above, the positioning of an object requires complicated calculations and corrections and the calculation result cannot be directly used for analyzing the moving behavior of the object. Substantially, in many positioning and tracking applications, only a range in which an object is located is required instead of the exact position thereof. Accordingly, simpler tag network positioning method and zone positioning method are provided.

According to the tag network positioning method, a RFID reader is disposed in each moving object, and a plurality of RFID tags is disposed in the environment to be tracked. Then, the region in which the object is located is determined according to the positions of the tags and signals received by the RFID reader from the object, and accordingly, the moving information of the object is obtained. The major problem of the tag network positioning method is that a RFID reader capable of wireless communication has to be disposed in each object. This method is not applicable to the positioning and tracking of large amount of objects due to the high cost of the RFID readers. Besides, this method is not suitable for being applied in human bodies due to the concern of the affection of radio frequency field or electric field effect to human health. In addition, if the passive RFID technique is adopted, the radiation wave will still be affected by environmental factors and accordingly the reading distance of the RFID reader disposed in the moving object will also affect the performance of the present method.

According to the zone positioning method, a tracked zone is divided into a plurality of regions, and a RFID reader is disposed in each of the regions. When the RFID tag carried by a moving object is read by one of the RFID readers, the object is considered being located in the corresponding region, and then the moving behavior of the object is analyzed according to the facts that the object enters and leaves different regions at different time. The problem of the zone positioning method is that blind spots may be produced if the RFID readers are sparsely distributed, namely, the regions read by the RFID readers do not overlap each other. On the other hand, if the RFID readers are densely distributed, namely, the regions read by the RFID readers overlap each other, a RFID tag may be read by multiple RFID readers so that the object carrying the RFID tag may be considered roaming about several regions. Thereby, the performance of the present method is restricted if it is directly applied to the analysis of object movement.

Foregoing conventional techniques also have a common program regarding the reading rate of the RFID reader. Thus, neither of them is suitable for the positioning of large amount of fast-moving objects. Because the RFID readers have very low processing efficiency, then if there are too many tags, the signals issued by the tags cannot be completely read within a limited reading time through the existing techniques. Besides, in an environment disposed with multiple RFID readers, the problem of overlapped reading of a same tag or interference between signals will be produced.

As described above, none of the existing technique for positioning and tracking a moving object is satisfactory enough.

### SUMMARY OF THE INVENTION

Accordingly, the present invention is directed to a method for analyzing signals from an electronic tag, wherein reader devices are flexibly organized so that the data collection of the electronic tag can be maximized, and a signal sequence received from the electronic tag is converted into a state sequence to be used for the tracking and analyzing of an moving object. The present method does not require any complicated positioning calculation and can effectively resolve the program of the conventional zone positioning method that the moving object cannot be detected or the signals detected are roaming about several regions.

The present method can not only be applied to the positioning and behavior analysis of large amount of fast-moving objects but also be quickly developed and applied to different environments and different moving behavior patterns.

The present invention is also directed to a computer-readable recording medium, wherein the recording medium records a program which executes foregoing method for analyzing signals from an electronic tag.

The present invention is further directed to a system for analyzing signals from an electronic tag, wherein the system executes foregoing method for analyzing the signals from the electronic tag.

The present invention provides a method for analyzing signals from an electronic tag. The method includes: (a) receiving the signals from the electronic tag through at least one reader device of at least one reading point (or referred as reading area), wherein each of the reading points includes at least one reader device, and each of the signals includes the identification (ID) of the reader device which receives the signal, the ID of the electronic tag, the reading time of the signal, and the received signal strength, etc; however, the content of the signal is not limited thereto; and (b) converting each of the signals into a pre-defined state through a data processing procedure according to the content of the signal and the definition of the reading points, and generating a temporary state sequence of each electronic tag from the states in the order of their occurrence time.

Through state definition and reading point (reading area) integration, a state of an electronic tag represents the relationship between the electronic tag and the reading area, and the state sequence thereof represents the movement of the electronic tag in each of the reading areas.

According to an embodiment of the present invention, the reader device ID may be a reader ID, an antenna ID, or the combination of the reader ID and the antenna ID.

According to an embodiment of the present invention, the step (b) includes following steps. First, the signals received during a predetermined sampling time duration are converted into reading point IDs corresponding to the reader device IDs of the signals according to the reader device IDs and/or other data. Then, the state of each of the electronic tags is determined according to the numbers of signals of the electronic tag received in the reading areas during the predetermined sampling time duration. After that, the determined state is added to the temporary state sequence.

According to an embodiment of the present invention, in step (b), the electronic tags are corresponded to the corresponding states according to the definition of the states and the distribution of the reading point ID.

According to an embodiment of the present invention, after step (b), the present method further includes: (c) comparing the temporary state sequence with at least one predetermined state sequence, wherein the predetermined state sequence is defined according to the sequential permutation of the states; and (d) executing a corresponding response procedure according to the comparison result.

According to an embodiment of the present invention, in step (d), different response procedure is executed according to whether there is a predetermined state sequence matching the temporary state sequence.

According to another embodiment of the present invention, in step (d), different response procedure is executed according to which predetermined state sequence the temporary state sequence matches.

According to an embodiment of the present invention, in step (d), the corresponding response procedure is executed according to the comparison result and the electronic tag ID.

The present invention also provides a computer-readable recording medium, wherein the recording medium records a program which executes foregoing method for analyzing signals from an electronic tag.

The present invention further provides a system for analyzing signals from an electronic tag. The system includes at least one reading point and an analyzing unit. Each of the reading points includes at least one reader device. The analyzing unit receives the signals from the electronic tag through the reader devices. Each of the signals includes at least one of the ID of the reader device which receives the signal, the electronic tag ID, the signal reading time, and the received strength of the signal. The analyzing unit also generates a temporary state sequence according to the reader device ID, the definition of the reading points, and the definition of a plurality of states, wherein the states are defined according logical combinations of the reading points.

According to the present invention, no complicated calculation or exact positioning of a moving object is required; instead, a signal sequence received from an electronic tag is converted into a state sequence through simple signal processing, then the state sequence is compared with a predetermined state sequence, and a corresponding response procedure is executed according to the comparison result. Moreover, in the present invention, signals from an electronic tag are received by several readers at the same time so that the problem of reading rate in the conventional technique can be resolved and the signals can be correctly analyzed even though the reading areas of the readers overlap each other. Thereby, in the present invention, the disadvantages of the conventional techniques, such as complicated calculations, instable signal strength, and affection of environmental factors, can be all avoided, the problem in the conventional zone positioning method that a moving object cannot be detected or detected to be roaming about several regions can be effectively resolved, and the present invention can be effectively applied to the positioning and behavior analysis of large amount of fast-moving objects.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A˜1E are diagrams illustrating the moving behavior patterns of an object according to an embodiment of the present invention.

FIG. 2 and FIG. 3 are flowcharts of a method for analyzing signals from an electronic tag according to an embodiment of the present invention.

FIG. 4 is a diagram of a system for analyzing signals from an electronic tag according to an embodiment of the present invention.

FIG. 5 is a diagram of a system for analyzing signals from an electronic tag according to another embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The technique provided by the present invention is a revision of the conventional zone positioning method, and which is applicable to the tracking and behavior analysis of moving objects, such as people or vehicles, carrying active or passive radio frequency identification (RFID) tags. Substantially, the present invention is not limited to RFID tags, and any electronic tag which can issue or respond wireless signals can be applied to the present invention. The method and system provided by the present invention for analyzing signals from electronic tags will be described below with reference to embodiments of the present invention.

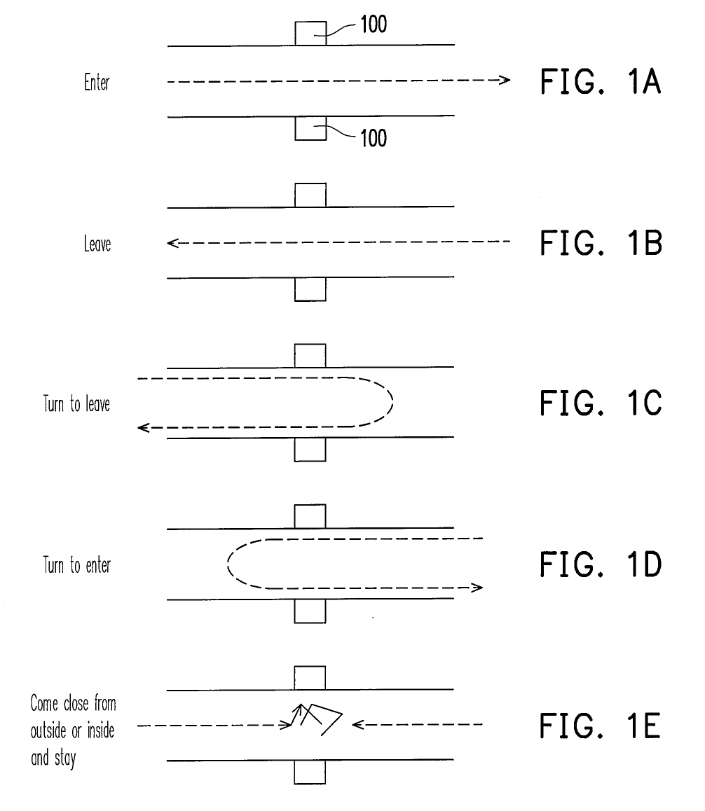

FIGS. 1A˜1E are diagrams illustrating the moving behavior patterns of an object according to an embodiment of the present invention. In the present embodiment, the objects to be tracked are people passing through a gate, wherein each person passing through the gate carries an electronic tag. Referring to FIG. 1A, the element 100 is the gate, left to the gate is the outside, and right to the gate is the inside. FIGS. 1A˜1E illustrate the five moving behavior patterns to be analyzed in the present embodiment, wherein FIG. 1A illustrates an entering behavior, FIG. 1B illustrates a leaving behavior, FIG. 1C illustrates a turning to leave behavior, FIG. 1D illustrates a turning to enter behavior, and FIG. 1E illustrates a behavior of coming close from outside or inside and then staying by the gate.

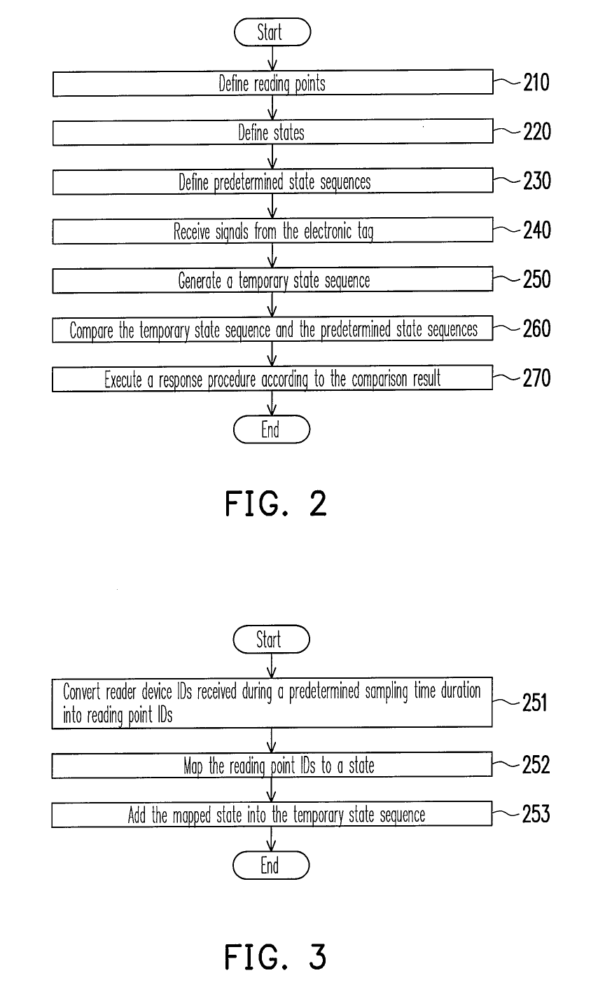

FIG. 2 and FIG. 3 are flowcharts of a method for analyzing signals from electronic tags according to the present embodiment, wherein the method is used for identifying and analyzing the moving behaviors illustrated in FIGS. 1A˜1E. FIG. 4 is a diagram of a system for analyzing signals from electronic tags according to the present embodiment. The method for analyzing the signals from electronic tags starts from step 210, wherein steps 210˜230 are to carry out all the settings, and steps 240˜270 are the actual procedure.

First, at least one reading point is defined for the signal analysis system (step 210), wherein the reading points (or referred as reading areas) are locations (areas) for receiving signals from the electronic tags in a site in which foregoing system is implemented, and each of the reading points may be composed of one or multiple electronic tag readers and antennas. As shown in FIG. 4, the signal analysis system in the present embodiment includes two reading points RPA and RPB, and each of the reading points includes two readers, wherein the reading point RPA includes readers R1 and R2, and the reading point RPB includes readers R3 and R4. The gate 100 is located at the junction (not shown) between the reading point RPA and the reading point RPB.

Generally speaking, each reading point includes at least one reader device. Here the reader device refers to a reader, an antenna, or the combination of a reader and an antenna according to the actual situation. A reader has to be disposed with an antenna to receive signals, and each reader can be disposed with one or multiple antennas. Each of the antennas disposed in a reader can receive signals from electronic tags independently, and each of the antennas can be placed at different location or even belong to different reading point. In order to meet all of foregoing situations and identify the reader device which receives a signal, each signal includes an identification (ID) of the reader device which receives the signal. The reader device ID has to be unique to allow the reader device which receives the signal to be correctly identified.

If only one antenna is disposed in each reader, since the reader itself has a unique ID, foregoing reader device may refer to the reader itself or the combination of the reader and the antenna, and accordingly, the reader device ID may be the reader ID or the combination of the reader ID and the antenna ID. If the antenna ID is also unique, then the reader device may refer to only the antenna and the reader device ID may refer to the antenna ID.

On the other hand, each reader may be disposed with one or more antennas. If the antenna ID is not unique, foregoing reader device may refer to the combination of readers and antennas, and the reader device ID may refer to the combination of reader ID and antenna ID. If the antenna ID is unique, then foregoing reader device may refer to antennas or the combination of readers and antennas, and accordingly the reader device ID may refer to antenna ID or the combination of reader ID and antenna ID.

In the present embodiment, all the electronic tag signals received by each of the reading points are considered from the same source regardless of which reader or antenna receives the signal. The number of readers and antennas of each of the reading points can be determined according to the expected maximum traffic so as to compensate for the low processing efficiency of the readers. As a result, the present embodiment is suitable for the tracking and behavior analysis of large amount of moving objects.

In the present embodiment, after the reading points are defined, all predetermined states are defined according to logical combinations of the reading points (step 220). All the states in the present embodiment are listed in following table 1.

TABLE 1
definition of states

| | State A | State B | State C | State D |
|---|---|---|---|---|
| Definition | A state that | A state that | A state that | A state that |
| | electronic tag | electronic tag | electronic tag | neither of the |
| | signals are read | signals are read | signals are read | reading points |
| | by only the | by only the | by both the | RPA and RPB |
| | reading point | reading point | reading points | receives any signal |
| | RPA (or a state | RPB (or a state | RPA and RPB | |
| | in which the | in which the | (or a state in | |
| | reading point | reading point | which each of | |
| | RPA reads most | RPB reads most | the reading | |
| | of the signals) | of the signals) | points RPA and | |
| | | | RPB reads a fair | |
| | | | portion of the | |
| | | | signals) | |

Next, at least one predetermined state sequence is defined according to the sequential permutation of foregoing states (step 230). These predetermined state sequences should include all the possible moving behavior patterns. The predetermined state sequences in the present embodiment are listed in following table 2.

The actual procedure for analyzing signals from electronic tags is to be started after the settings in steps 210˜230 are completed. Next, signals are constantly received from electronic tags by readers and antennas in the reading points (step 240). Each of the signals includes at least an ID of the electronic tag and the ID of the reader device which receives the signal, and the signal may further include the reading time of the signal, the signal strength when the signal is read, and other related information. All the signals are collected and analyzed together by an analyzing unit (not shown) of the signal analysis system, and signals received from different electronic tags are processed separately. The analyzing unit includes a computer-readable recording medium, and a program recorded in the recording medium executes steps 240˜270.

Thereafter, the signals received from the same electronic tag are converted into a temporary state sequence according to the reader device ID in each of the signals, the definition of all the reading points, and the definition of all the states (step 250). The step 250 can be further divided into steps 251˜253 as illustrated in FIG. 3, and which will be described below in detail.

TABLE 2
definition of predetermined state sequence

| Predetermined state sequence | Corresponding behavior pattern |
|---|---|
| D -> A -> C -> B -> D | Entering, as shown in FIG. 1A |
| D -> B -> C -> A -> D | Leaving, as shown in FIG. 1B |
| D -> A -> A -> D or | Returning to leave, as shown in FIG. 1C |
| D -> A -> C -> A -> D | |
| D -> B -> B -> D or | Returning to enter, as shown in FIG. 1D |
| D -> B -> C -> B -> D | |
| D -> A -> A -> A or | Coming close and staying, as shown in |
| D -> A -> C -> C -> C or | FIG. 1E |
| D -> B -> B -> B or | |
| D -> B -> C -> C -> C | |

In the present embodiment, the signals are received in units of a predetermined sampling time duration, and the signals received during the same predetermined sampling time duration are analyzed and processed as the same group of signals. First, the reader device ID of all the signals received during the same predetermined sampling time duration are converted into reading point IDs of reading points including the reader devices having these reader device IDs (step 251). As shown in FIG. 4, RPA and RPB are reading point IDs, and R1˜R4 are reader device IDs. Assuming that the reader device IDs of all the signals received during a specific sampling time duration from a specific electronic tag are {R1, R2, R4, R4, R3, R1, R1, R2}, then the converted reading point IDs are {RPA, RPA, RPB, RPB, RPB, RPA, RPA, RPA}.

Next, the set of reading point IDs generated in step 251 is mapped to one of the four states listed in table 1 according to the state definition in table 1 (step 252). The simplest method is to distinguish the states according to the existence of reading point IDs in the set. For example, a set containing only RPA is mapped to the state A, a set containing only RPB is mapped to the state B, a set containing both RPA and RPB is mapped to the state C, and an empty set is mapped to the state D.

Another method is to map the set of reading point IDs to one of the states according to the state definition in table 1 and the distribution proportions of the reading point IDs in the set. For example, the set is mapped to the state A when the number of RPA takes up more than 80% of the total number of reading point IDs in the set; the set is mapped to the state B when the number of RPB takes up more than 80% of the total number of reading point IDs in the set; the set is mapped to the state C when each of RPA and RPB takes up 20%˜80% of the total number of reading point IDs in the set; and an empty set is mapped to the state D.

After the set of reading point IDs is mapped to a state, the mapped state is then added into the temporary state sequence (step 253). Through the same procedure, a second mapped state is added into the temporary state sequence during the next sampling time duration, and a third mapped state is added into the temporary state sequence during another sampling time duration, and so on. As a result, the temporary state sequence is obtained.

Referring to FIG. 2 again, after the temporary state sequence is generated, the temporary state sequence is compared with the predetermined state sequences in table 2 (step 260). The temporary state sequence may be compared with the predetermined state sequences through a pattern matching technique. Each of the predetermined state sequences is corresponding to a behavior pattern, and the behavior pattern may be referred as a moving event. Accordingly, a corresponding response procedure can be executed according to the comparison result between the temporary state sequence and the predetermined state sequences (step 270).

In the present embodiment, different response procedure is executed according to different comparison result. For example, a corresponding predetermined state sequence can be defined regarding every acceptable or expectable behavior pattern. After that, a normal event response procedure is executed when the temporary state sequence matches one of the predetermined state sequences, and an abnormal event response procedure is executed when the temporary state sequence does not match any one of the predetermined state sequences. The normal event response procedure can be further divided so that different normal event response procedure can be executed when the temporary state sequence matches different predetermined state sequence.

Complete tracking and management to people and vehicles passing through the gate 100 can be accomplished based on the response mechanism described above. Besides, related information can be automatically sent to staffs in charge. For example, the system can automatically inform a receptionist if someone enters the gate normally. Everyone's movement is automatically recorded so that if someone presents a suspectable moving pattern, such as moving too slow, wandering about, disappearing suddenly, or presenting an unexpected moving pattern, a message is issued to notify the security stalls.

In foregoing response mechanism, every moving object is tracked equally. However, the present embodiment can be further implemented so that different response procedure can be executed according to the comparison result between the temporary state sequence and the predetermined state sequences and the electronic tag ID in the received signal. For example, the electronic tag ID of each person can be corresponded to different security level, and each security level has corresponding areas. The person with the highest security level can enter all the areas without triggering the alarm, while a person with lower security level will trigger the alarm if he/she enters a higher level area.

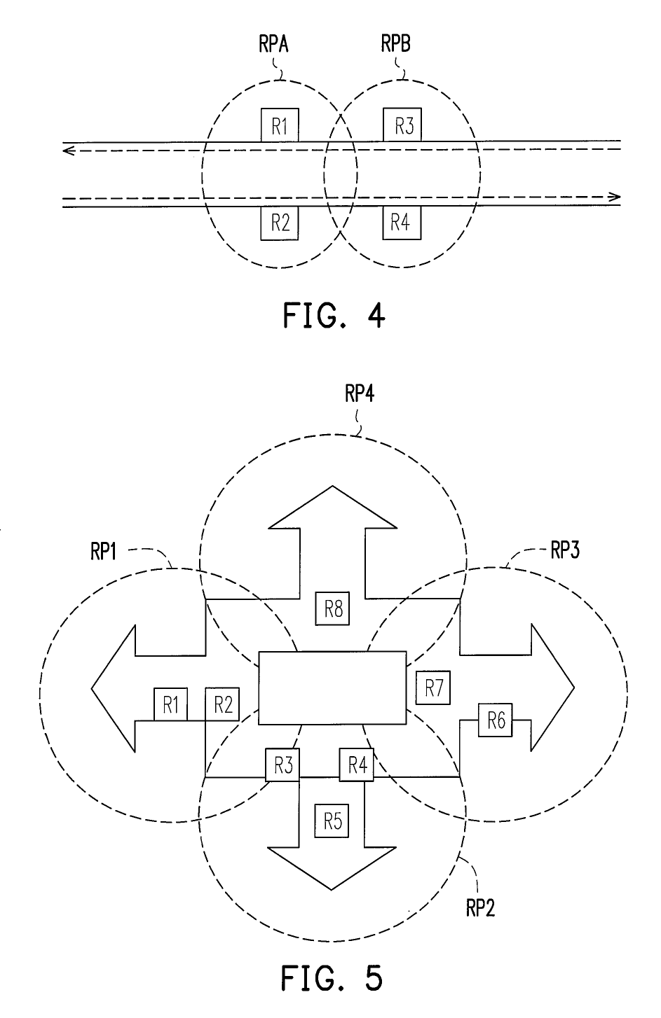

Foregoing embodiment is applied only to the tracing and analysis in a one-dimensional space; however, other embodiments of the present invention can be applied to two-dimensional space or three-dimensional space composed of on&-dimensional and two-dimensional spaces. FIG. 5 illustrates an example of application of the present invention in a two-dimensional space. Referring to FIG. 5, in the signal analysis system, a room has four exits, and eight electronic tag readers R1˜R8 are respectively disposed at the four exits. In the present embodiment, four reading points RP1˜RP4 are defined, wherein the reading point RP1 includes two readers R1 and R2, the reading point RP2 includes three readers R3˜R5, the reading point RP3 includes two readers R6 and R7, and the reading point RP4 includes only one reader R8. Any moving object coming into or leaving the room can be tracked according to the predetermined state sequences defined by the reading points RP1˜RP4. As described above, other embodiments of the present invention can be easily applied to three-dimensional spaces. For example, the present invention can be implemented for tracking moving objects on all floors in a building.

In overview, the present invention is a revision of the conventional zone positioning method, wherein no complicated positioning calculation is required so that disadvantages of the conventional positioning technique that signal characteristics are easily affected by environmental factors can be avoided and the problems in the conventional zone positioning method that moving object cannot be detected or detected to be roaming about different regions can be effectively resolved.

Regarding the bottleneck of reading rate in the conventional technique, the present invention allows the flexibly in reading a plurality of electronic tags at the same time by using a plurality of readers and can flexibly integrate signals received by each of the readers. Thus, an optimal signal reading rate can be achieved. Thereby, the present invention can be effectively applied to the tracking and behavior analysis of large amount of fast-moving objects.

In the present invention, the signals received from electronic tags by each of the reading points are converted into a temporary state sequence, and the temporary state sequence is then compared with flexibly defined predetermined state sequences so that different response procedure can be executed according to different comparison result. Such a mechanism can simplify the behavior analysis to moving objects. Moreover, according to the present invention, the definitions of the reading points, the states, and the predetermined state sequences are all easily adjusted therefore can be quickly applied to the behavior analysis in different environments and moving behavior patterns.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for analyzing signals from an electronic tag, comprising:
(a) receiving at least one signal from the electronic tag through at least one reader device of at least one reading point, wherein each of the reading points comprises at least one said reader device, and each of the signals comprises at least one of an identification (ID) of the reader device which receives the signal, an ID of the electronic tag, the reading time of the signal, and the received strength of the signal; and
(b) generating a temporary state sequence according to the reader device ID, the definition of the reading points, and the definition of a plurality of states, wherein the states are defined according to logical combinations of the reading points.

2. The method according to claim 1, wherein the reader device ID comprises at least one of a reader ID and an antenna ID.

3. The method according to claim 1, wherein step (b) comprises:
converting the reader device IDs of the signals received during a predetermined sampling time duration into reading point IDs of the reading points comprising the reader devices having the reader device IDs;
mapping a set of the reading point IDs to one of the states according to the definition of the states; and
adding the mapped state into the temporary state sequence.

4. The method according to claim 3, wherein step (b) further comprises:
mapping the set to one of the states according to the definition of the states and distribution proportions of the reading point IDs in the set.

5. The method according to claim 1, wherein after step (b), the method further comprises:
(c) comparing the temporary state sequence with at least one predetermined state sequence, wherein the predetermined state sequence is defined according to a sequential permutation of the states; and
(d) executing a corresponding response procedure according to the comparison result.

6. The method according to claim 5, wherein step (d) comprises:
executing a first response procedure if the temporary state sequence matches one of the predetermined state sequences; and
executing a second response procedure if the temporary state sequence does not match any one of the predetermined state sequences.

7. The method according to claim 5, wherein step (d) comprises:
executing a first response procedure if the temporary state sequence matches one of the predetermined state sequences; and
executing a second response procedure if the temporary state sequence matches another one of the predetermined state sequences.

8. The method according to claim 5, wherein step (d) comprises:
executing the corresponding response procedure according to the comparison result and the electronic tag ID.

9. A system for analyzing signals from an electronic tag, comprising:
at least one reading point, wherein each of the reading points comprises at least one reader device; and
an analyzing unit, for receiving the signals from the electronic tag through the reader devices, wherein each of the signals comprises at least one of an ID of the reader device which receives the signal, an ID of the electronic tag, the reading time of the signal, and the received strength of the signal; the analyzing unit further generating a temporary state sequence according to the reader device ID, the definition of the reading points, and the definition of a plurality of states, wherein the states are defined according to logical combinations of the reading points.

10. The system according to claim 9, wherein the reader device ID comprises at least one of a reader ID and an antenna ID.

11. The system according to claim 9, wherein the analyzing unit further converts the reader device IDs of the signals received during a predetermined sampling time duration into reading point IDs of the reading points comprising the reader devices having the reader device IDs, maps a set of the reading point IDs to one of the states according to the definition of the states, and adds the mapped state into the temporary state sequence.

12. The system according to claim 11, wherein the analyzing unit further maps the set to one of the states according to the definition of the states and distribution proportions of the reading point IDs in the set.

13. The system according to claim 9, wherein the analyzing unit further compares the temporary state sequence with at least one predetermined state sequence and executes a corresponding response procedure according to the comparison result, wherein the predetermined state sequence is defined according to a sequential permutation of the states.

14. The system according to claim 13, wherein the analyzing unit executes a first response procedure if the temporary state sequence matches one of the predetermined state sequences, and the analyzing unit executes a second response procedure if the temporary state sequence does not match any one of the predetermined state sequences.

15. The system according to claim 13, wherein the analyzing unit executes a first response procedure if the temporary state sequence matches one of the predetermined state sequences, and the analyzing unit executes a second response procedure if the temporary state sequence matches another one of the predetermined state sequences.

16. The system according to claim 13, wherein the analyzing unit further executes the corresponding response procedure according to the comparison result and the electronic tag ID.

17. A computer-readable recording medium, for recording a program, wherein the program executes a method for analyzing signals from an electronic tag, and the method comprises:
(a) receiving the signals from the electronic tag through at least one reader device of at least one reading point, wherein each of the reading points comprises at least one said reader device, and each of the signals comprises at least one of an ID of the reader device which receives the signal, an ID of the electronic tag, the reading time of the signal, and the received strength of the signal; and
(b) generating a temporary state sequence according to the reader device ID, the definition of the reading points, and the definition of a plurality of states, wherein the states are defined according to logical combinations of the reading points.

18. The computer-readable recording medium according to claim 17, wherein the reader device ID comprises at least one of a reader ID and an antenna ID.

19. The computer-readable recording medium according to claim 17, wherein step (b) comprises:
converting the reader device IDs of the signals received during a predetermined sampling time duration into the reading point IDs of the reading points comprising the reader devices having the reader device IDs;
mapping a set of the reading point IDs to one of the states according to the definition of the states; and
adding the mapped state into the temporary state sequence.

20. The computer-readable recording medium according to claim 19, wherein step (b) further comprises:
mapping the set to one of the states according to the definition of the states and distribution proportions of the reading point IDs in the set.

21. The computer-readable recording medium according to claim 17, wherein after step (b), the method further comprises:
(c) comparing the temporary state sequence with at least one predetermined state sequence, wherein the predetermined state sequence is defined according to a sequential permutation of the states; and
(d) executing a corresponding response procedure according to the comparison result.

22. The computer-readable recording medium according to claim 21, wherein step (d) comprises:
executing a first response procedure if the temporary state sequence matches one of the predetermined state sequences; and
executing a second response procedure if the temporary state sequence does not match any one of the predetermined state sequences.

23. The computer-readable recording medium according to claim 21, wherein step (d) comprises:
executing a first response procedure if the temporary state sequence matches one of the predetermined state sequences; and
executing a second response procedure if the temporary state sequence matches another one of the predetermined state sequences.

24. The computer-readable recording medium according to claim 21, wherein step (d) comprises:
executing the corresponding response procedure according to the comparison result and the electronic tag ID.
